(19) United States
(12) Patent Application Publication
(10) Pub. No.: US 2021/0133688 A1
(43) Pub. Date: May 6, 2021

(54) CALENDAR INSIGHTS IN SEARCH AND ASSISTANCE

(71) Applicant: Microsoft Technology Licensing, LLC, Redmond, WA (US)

(72) Inventors: Christopher Shingee Park, Issaquah, WA (US); Siddhant Mehta, Vancouver (CA)

(21) Appl. No.: 16/731,967

(22) Filed: Dec. 31, 2019

Related U.S. Application Data
(60) Provisional application No. 62/929,707, filed on Nov. 1, 2019.

(51) Int. Cl. G06Q 10/10; G06F 9/54; H04L 12/58

(52) U.S. Cl. CPC G06Q 10/1093; H04L 51/046; G06F 9/542

(57) ABSTRACT

Non-limiting examples of the present disclosure describe systems, methods, and devices for identifying events comprising one or more issues and for generating, surfacing, and interacting with event triage notifications in a zero-query environment. An input to access a application interface may be received. An event comprising one or more unresolved issues may be identified. A notification may be surfaced on the application interface. The notification may be selectable to resolve the event's one or more unresolved issue. The application interface may be associated with an event organizer and/or an event invitee and may be accesses via a mobile device.

### RELATED APPLICATIONS

This application hereby claims the benefit of, and priority to, U.S. Provisional Patent Application No. 62/929,707, entitled “EVENT TRIAGE FROM ZERO-QUERY SEARCH”, filed Nov. 1, 2019, and which is hereby incorporated by reference in its entirety for all purposes.

### BACKGROUND

Electronic calendars and other productivity applications are increasingly relied upon to organize events in our lives. Such calendars and productivity applications are accessed via desk top computers and mobile computing devices (e.g., laptop computers, tablet computers, mobile phones, wearable devices, etc.), for example, when a person wants to review details about one or more events.

Events saved to an electronic calendar or other productivity application are difficult to manage efficiently. For example, to determine if a user has agreed to attend multiple events occurring on the same date and at the same time, a user must open each of his or her electronic calendars and/or one or more productivity applications and check for possible conflicting events. Additionally, to prepare for future events, the user must open each event individually and identify what information may be required to prepare for the event and what actions remain outstanding. Users of small form factor devices (i.e., mobile phones, tablets, etc.) find it particularly challenging to perform these tasks.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods, and devices for providing event triage solutions in zero-query environments. The event triage solutions are useful in efficiently managing future events and the time required to prepare for said events by providing users with advanced insights to address issues before an event begins. In an implementation, an event triage solution includes a zero-query/event triage application and/or service that identifies an issue associated with an event. The issue comprises one or more tasks that have not been addressed at the time the zero-query/event triage application identified the issue. The zero-query/event triage application surfaces the notification in a user interface. The notification comprises a selectable triage element that, when selected, causes implementation of a solution to resolve the identified issue.

Thus, these systems, methods, and devices provide new, more efficient means for providing event triage solutions.

### BRIEF DESCRIPTION OF THE DRAWINGS

Non-limiting and non-exhaustive examples are described with reference to the following figures:

FIG. 1 is a schematic diagram illustrating an example distributed computing environment in an implementation.

FIG. 2 illustrates a user interface comprising example event triage notifications in an implementation.

FIG. 3 illustrates a zero-query interface surfaced on a mobile device in an implementation.

FIG. 4 illustrates a computing environment for node processing in a graphical matrix for providing event triage in an implementation.

FIG. 5 is an exemplary method for providing event triage in an implementation.

FIG. 6 is an exemplary method for providing event triage in an implementation.

FIGS. 7 and 8 are simplified diagrams of a mobile computing device with which aspects of the disclosure may be practiced.

FIG. 9 is a block diagram illustrating example physical components of a computing device with which aspects of the disclosure may be practiced.

FIG. 10 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Non-limiting examples of the present disclosure describe systems, methods and devices for identifying events comprising one or more issues and for generating, surfacing, and interacting with event triage notifications in a zero-query environment. According to examples, a zero-query/event triage application and/or service identifies an event that has at least one unresolved issue (i.e., an issue that has not yet been remedied or resolved). The zero-query/event triage application and/or service may be a proactive search system that models and analyzes behaviors (e.g., user behavior with an application, user behavior with other users, interactions of users with a resource, etc.) to generate notifications. Notifications may be used in a zero-query environment to automatically push information to a user via an application on a mobile device. Unlike traditional reactive Web search systems where the search engines return results in response to queries issued by users, a proactive search system may actively push one or more notifications to a user via a computing device based on contextual information (e.g., time, location, environment, weather, user interests, future events, etc.). Notifications, therefore, may be surfaced in an electronic device in response to a particular contextual trigger and not as a result of an explicit query made by a user. While according to some examples, the zero-query/event triage application and/or service may be stand-alone, in other examples it may be incorporated in the operating system and/or as a shell construct.

A first type of unresolved issue corresponds to resources identified for recommended reading and/or reviewing. The resources may be identified from a graphical matrix comprising a plurality of resources. For example, a determination may be made based on the edges in the graphical matrix and the various attributes of the resources as to what extent the resources may relate to an event. In some examples, the edges in the graph may be explicit (e.g., resource attachments, embedded resource links, etc.). In other examples, the edges in a graph may be implied (e.g., based on attribute overlap, based on textual reference, etc.). In some examples, one or more natural language processing models and/or machine learning models may be applied to resources to determine whether they relate to an event (e.g., does an event details page contain an event agenda, is a document relevant to a topic that will be discussed during an event, etc.).

For this first type of unresolved issue, suggested solutions may be presented in a user interface of a zero-query application via notifications that comprise one or more user interface elements that may provide an indication of one or more resources (e.g., documents, event agendas, etc.) that a user (event invitee, event organizer) associated with the event should read or preview prior to the event. In some examples, these suggested solutions may be interacted with to surface and open any suggested event pre-reads.

A second type of unresolved issue corresponds to an event attendance rate that fails to meet a quorum (e.g., a threshold value for the number of invitees affirmatively attending an event has not been met). The quorum may relate to a number of invitees that have accepted, declined, and/or answered tentatively that they will attend an event. In some examples, when event attendance is determined to be relatively low based on the quorum, then suggested solutions may be presented in a user interface of a zero-query application via notifications that comprise one or more user interface elements that may be interacted with to reschedule the event to increase the likelihood of obtaining a better attendance rate.

A third type of unresolved issue corresponds to one or more event invitees proposing a modification to the event date and/or time. For this type of issue, suggested solutions may be presented in a user interface of a zero-query application via notifications that comprise one or more user interface elements that may be interacted with to view the proposal and/or to reschedule the event.

A fourth type of unresolved issue corresponds to an event missing location information for where the event is to be held and/or missing an option for invitees to attend the event remotely. For this type of unresolved issue, suggested solutions may be presented in a user interface of a zero-query application via notifications that comprise one or more user interface elements that may be interacted with to add an event location and/or add a remote-access option. In examples, one or more locations may be intelligently suggested for the event based on identification of open conference rooms, past event scheduling, user preferences, etc.

A fifth type of unresolved issue corresponds to multiple events scheduled for the same date and time (i.e., the events are double-booked). For this type of unresolved issue, suggested solutions may be presented in a user interface of a zero-query application via notifications that comprise one or more user interface elements that may be interacted with to reschedule and/or cancel one or more of the double-booked events and/or to contact an invitee and/or organizer of one or more of the double-booked events. In examples, one or more dates and times may be intelligently suggested for one or more of the events based on identification of open time-slots in invitees' calendars, user preferences, etc.

A sixth type of unresolved issue corresponds to identification of an incomplete assignment. For this type of unresolved issue, suggested solutions may be presented in a user interface of a zero-query application via notifications that comprise one or more user interface elements that may be interacted with to open productivity applications identified based on an application's functionality and its usefulness in completing an assignment (e.g., opening a dialer application to contact vendors, opening a word processing application to draft an agenda, etc.).

The systems, methods, and devices described herein provide technical advantages for addressing issues that arise when scheduling events, preparing for events, attending events, and performing follow-up actions associated with events. For example, existing solutions require users to open each of their electronic calendars and/or productivity applications to determine if a conflict exists with an event or if an action remains outstanding with regard to preparing for the event. The systems, methods, and devices described herein reduce processing costs (i.e., CPU cycles) over existing solutions at least by providing notifications of event conflicts and outstanding actions in a single location (e.g., a user interface to a zero-query application). The notifications may provide a brief summary of any identified issues (e.g., conflicts, outstanding actions, suggested readings, event locations, attendees, invitees, etc.) or a detailed summary of any identified issues as well as propose solutions for addressing any identified issues. For example, if an identified issue comprises a suggested reading, then the document and/or related event material may be automatically identified and a link to said document and/or reading material provided rather than having a user perform various manual searches for those resources (e.g., email searches, file searches, cloud directory searches, etc.). Processing costs are also reduced via the mechanisms described herein in that remote events over computing devices that would be poorly attended due to a low event acceptance rate can be rescheduled via interaction with a corresponding notification.

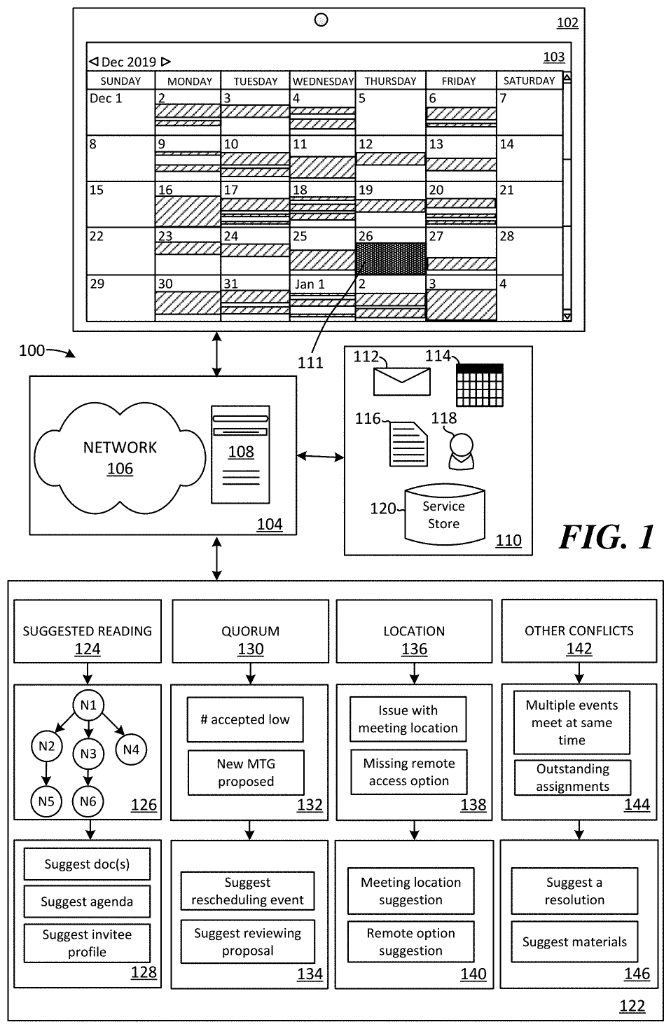

FIG. 1 is a schematic diagram illustrating an example distributed computing environment 100 for providing event triage in an implementation. Computing environment 100 includes computing device 102, network and processing sub-environment 104, service store sub-environment 110, and zero-query/event triage sub-environment 122.

Network and processing sub-environment 104 includes network 106, by which any of the computing devices described herein may communicate with one another, and server computing device 108, which is exemplary of a cloud-computing device that may perform one or more operations described herein in relation to a cloud-based application service (e.g., a calendar application service and/or a zero-query/event triage application service, an email application service, a document application service, etc.).

Service store sub-environment 110 comprises service store 120, which contains information associated with a plurality of users' electronic calendar/scheduling applications, including documents 116, user information 118, past, present, and future calendar events 114, and event invitations 112 associated with past, present and future events. Documents 116 may include productivity application documents that are stored locally to a local computing device such as computing device 102 and/or one or more remote storage locations. Documents 116 may comprise one or more documents of one or more document types, including one or more of: emails, saved instant messages, word processing documents, presentation documents, spreadsheet documents, note application documents, etc. Server computing device 108 and an associated zero-query/event triage application and/or service may communicate with service store 120 and obtain and analyze information included therein while performing one or more operations described herein.

In this example, a future event 111 has been identified by the zero-query/event triage application and/or service in electronic calendar 103. Electronic calendar 103 may be associated with one or more user accounts in service store 120 and/or the zero-query/event triage application and/or service. According to examples, when an event is identified by the zero-query/event triage application and/or service it may be processed by one or more elements and/or application engines illustrated in relation to zero-query/event triage sub-environment 122.

Zero-query/event triage sub-environment 122 includes suggested reading processing flow 124, which includes resource graph processing element 126 and suggested event triage output element 128. Zero-query/event triage sub-environment 122 further includes event quorum processing flow 130, which includes invitee response monitoring processing element 132 and suggested event triage output element 134. Zero-query/event triage sub-environment 122 also includes location processing flow 136, which includes event location and remote access processing element 138 and suggested event triage output element 140. Zero-query/event triage sub-environment 122 further includes other conflicts processing flow 142, which includes event conflicts processing element 144 and suggested event triage output element 146.

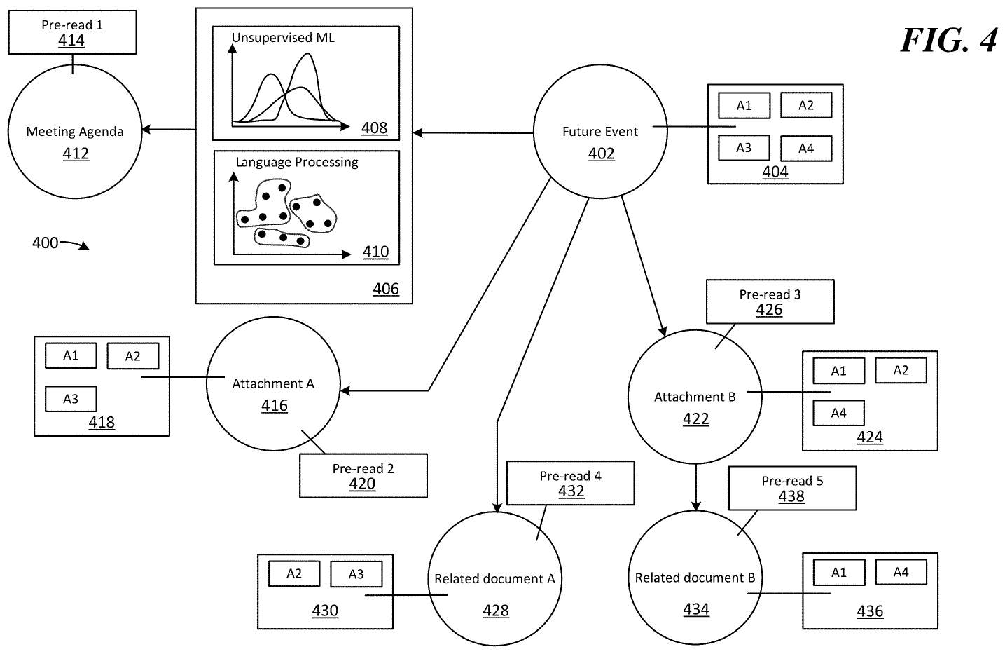

Suggested reading processing flow 124 illustrates the processing of data to identify events comprising unresolved issues such as events that have documents and/or resources that are identified as being useful for event invitees to read and/or review prior to attending the event but have not yet been read and/or reviewed by at least one invitee. The determination of whether a document and/or resource may be related to an event, and therefore useful for an invitee to read and/or review prior to attending the event, may comprise identifying links between nodes in a graphical matrix, such as that illustrated by resource graph processing element 126 and as more fully described in relation to FIG. 4. In some examples, these links, or “edges” may be explicit (e.g., resource attachments, embedded resource links, invitees listed in the event details, etc.). In other examples, the edges in a graph may be implied (e.g., based on attribute overlap, based on textual reference, etc.).

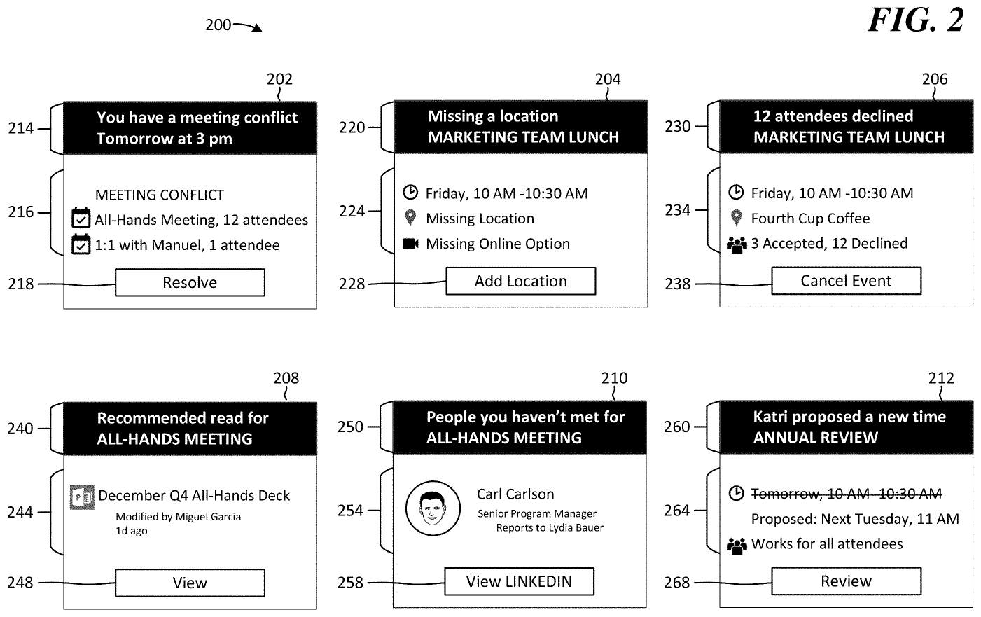

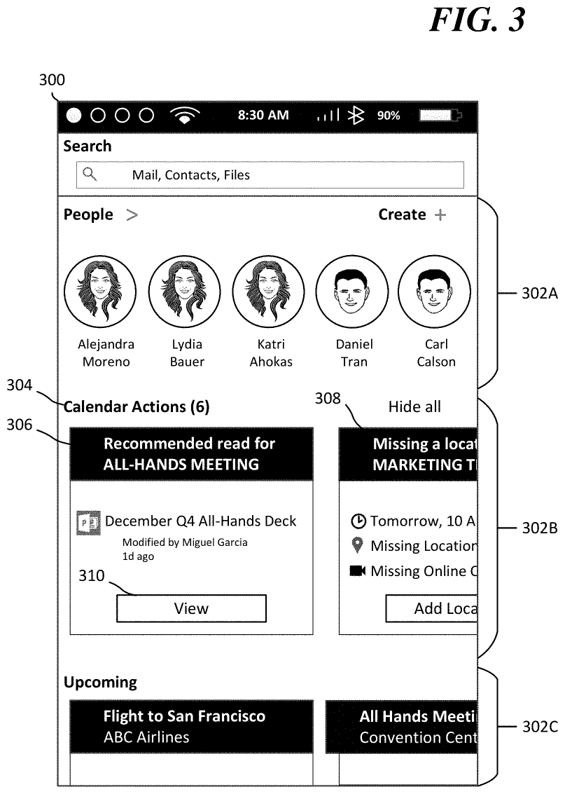

In some embodiments, when documents and/or resources are determined to be related to an event, one or more selectable event-triage elements corresponding to those documents and/or resources may be surfaced in one or more notifications as is more fully described in relation to FIG. 2 and FIG. 3. The notifications may be surfaced in association with an application of an event organizer and/or an application of an event invitee. The selectable event-triage elements may be selected to open the related documents and/or resources on a computing device and/or to set a reminder to review those materials. The surfacing of the selectable event-triage elements and related documents and/or resources (e.g., attachments, related productivity documents, event agendas, suggested emails, messaging chats, notes, event transcription excerpts, social media profiles, etc.) is illustrated by suggested event triage output element 128. the surfacing of related documents and/or resources is an example of implementing a solution to resolve an issue.

Event quorum processing flow 130 illustrates the processing of data to identify events comprising unresolved issues such as events where a threshold number, percentage, and/or ratio (i.e., threshold value) of event invitees have failed to positively affirm (i.e., accept) that they will attend the event (i.e., a quorum was not met). In some embodiments, when an event is identified as failing to meet a quorum, then one or more selectable event-triage elements for canceling the event and/or for changing the event date and/or time may be surfaced. Event quorum processing flow 130 also illustrates the processing of data to identify events where one or more invitees to the event have suggested rescheduling the event (i.e., an invitee made a proposal). In some embodiments, when an event is identified as having a proposal from an invitee, then one or more selectable event-triage elements for rescheduling the event and/or responding to an invitee may be surfaced. The selectable event-triage elements may be surfaced in one or more notifications as more fully described in relation to FIG. 2 and FIG. 3. The notifications may be surfaced in association with an application of the event organizer and/or an application of the event invitee. The surfacing of the selectable event-triage elements and/or generation of automatic messages for responding to an invitee that has proposed rescheduling the event is illustrated by suggested event triage output element 134. In some embodiments, rescheduling or canceling an event for which a quorum was not met, reviewing and/or responding to a proposal made by an invitee, and rescheduling or canceling an event in response to a proposal made by an invitee are examples of implementing a solution to resolve an issue.

With regard to the threshold value of event invitees that have failed to accept an event invitation, the threshold value may be modified (e.g., by the organizer, by the developer). Additionally, invitee responses to an event invite of “tentative” may also be included in the determination of whether to surface an event-triage element corresponding to a suggested rescheduling of the event. The processing of the data to determine whether the threshold value has been met and/or whether an invitee has proposed rescheduling the event is illustrated by invitee response monitoring processing element 132.

Location processing flow 136 illustrates the processing of data to identify events comprising unresolved issues such as events where there is an issue with an event location included (or not included) in event details. In some embodiments, if a determination is made that there is no event location associated with the details of an event and/or there is an issue with an event location (e.g., a single conference room is booked for multiple events having the same date and time, an event location is closed during a proposed event date and time, etc.), then one or more selectable event-triage elements for adding a location or updating a location may be surfaced. Location processing flow 136 also illustrates the processing of data to determine whether there is an issue with a remote-access option included (or not included) in event details that would enable invitees to attend the event remotely (e.g., over a network connection). In other embodiments, when a determination is made that there is no remote-access option available for an event, then one or more selectable event-triage elements for adding a remote-access option may be surfaced. The selectable event-triage elements may be surfaced in one or more notifications as more fully described in relation to FIG. 2 and FIG. 3. The notifications may be surfaced in association with an application of an event organizer and/or an application associated with an event invitee. A remote attendee and/or the event organizer may add a remote-access option to an event. In an example, when a remote attendee adds a remote-access option to an event, a notification comprising details about the remote-access option may be sent to the event organizer. The processing of data related to event location issues and/or issues related to remote access is illustrated by event location and remote access processing element 138, and the surfacing of selectable event-triage elements related to the event location issues and/or remote access issues is illustrated by suggested event triage output element 140. In some embodiments, the adding a location to an event, updating a location to an event, and adding a remote-access option to an event are examples of implementing a solution to resolve an issue.

Other conflicts processing flow 142 illustrates the processing of data to identify events comprising unresolved issues such as events where a date and time conflict exists between two or more events and/or assignment associated with the event remains outstanding (e.g., materials need to be prepared such as slide presentations, agendas, deliverables, etc.; vendors need to be booked; equipment needs to be rented; etc.). Options for triaging other conflicts may include: rescheduling a conflicting event; sending a message to an invitee to reschedule a conflicting event; canceling a conflicting event; opening a productivity application in a user interface, which may enable a user to begin drafting a deliverable; opening a dialer application in a user interface, which may enable a user to contact a vendor; or any other action that facilitates implementing event triage. In some embodiments, when an event is identified as comprising a conflict, then one or more selectable event-triage elements corresponding to the conflict may be surfaced in one or more notifications as is more fully described in relation to FIG. 2 and FIG. 3. Notifications associated with other conflicts processing flow 142 may be surfaced in association with an application of the event organizer and/or an application of the event invitee. The processing of the data to identify other conflicts is illustrated by event conflicts processing element 144, and the surfacing of the selectable event-triage elements and/or any productivity applications is illustrated by suggested event triage output element 146. In some embodiments, implementing either of the options for triaging other conflicts discussed above is an example of implementing a solution to resolve an issue.

FIG. 2 illustrates a user interface 200 comprising examples of event triage notifications as they may appear in examples. User interface 200 includes meeting conflict type notification 202, missing location type notification 204, quorum type notification 206, recommended reading type notification 208, profile type notification 210, and proposal type notification 212, all of which are examples of event triage notifications. In implementations, one or more of the event triage notifications depicted on user interface 200 may be included only on an event organizer's user interface view (e.g., missing location type notification 204, quorum type notification 206, proposal type notification 212 may be included on an organizer's user interface view and not on an attendee's user interface view). In other examples, each of the example event triage notifications depicted on user interface 200 may be included on both the organizer's user interface and an invitee's user interface view. More or fewer event triage notifications may be included on a user interface view, and different arrangements and specific user interface configurations for displaying event triage notifications are contemplated than are shown in relation to FIG. 2.

When an issue is identified in association with an event, the issue may be classified as one or more issue types. The appropriate issue type to apply to an issue may be determined based on one or more factors associated with one or more events. Subsequent to classifying the issue, an event triage notification may be generated comprising multiple elements (e.g., a brief summary of the one or more identified issues, a detailed summary of the one or more identified issues, one or more selectable event-triage elements, etc.). While in some examples, the event triage notification comprises a selectable triage element that is selectable to resolve one or more issues, in other examples the event triage notification is selectable to resolve the one or more issues. In some examples, a priority criterion may be applied to the event triage notification whereby multiple event triage notifications may be surfaced in a user interface in an order corresponding to the priority criterion. The priority criterion may be based on a determined urgency to resolve the issue (e.g., models of user behavior indicate that a specific issue should be resolved immediately, models of user behavior indicate that a specific issue may be resolved later than another unresolved issue, an event is scheduled to occur next in a user's calendar application or other productivity application, etc.) and/or the time it takes to complete a task that may resolve the identified issue (e.g., models of user behavior indicate that a user typically needs one week to prepare a presentation, two hours to prepare a three-page document, etc.).

In the present example, meeting conflict type notification 202 may have been generated in response to detecting one or more issues based on one or more factors associated with one or more events (i.e., the All-Hands Meeting is scheduled at the same time as the 1:1 with Manuel). The one or more issues may have subsequently been classified as a “meeting conflict type” for which the meeting conflict type notification 202 was generated comprising meeting conflict type issue summary 214 (i.e., “You have a meeting conflict Tomorrow at 3 pm”); meeting conflict type detailed summary 216, which describes in more detail the one or more issues; and selectable triage element 218, which is selectable to implement a suggested solution that may resolve the one or more issues. A priority criterion may have been applied to meeting conflict type notification 202 such that meeting conflict type notification 202 may be surfaced prior to, or after, surfacing missing location type notification 204, quorum type notification 206, recommended reading type notification 208, profile type notification 210, and proposal type notification 212.

In the present example, missing location type notification 204 may have been generated in response to detecting one or more issues based on one or more factors associated with an event (i.e., MARKETING TEAM LUNCH is missing a location at which to hold the event as well as a remote-access option). The one or more issues may have subsequently been classified as “missing location type” for which the missing location type notification 204 was generated comprising missing location type issue summary 220; missing location type detailed summary 224, which describes in more detail the identified issues; and selectable triage element 228, which is selectable to implement a suggested solution that may resolve the identified issue (e.g., add a location to the event, add an online access option to the event). A priority criterion may have been applied to missing location type notification 204 such that missing location type notification 204 may be surfaced prior to, or after, surfacing meeting conflict type notification 202, quorum type notification 206, recommended reading type notification 208, profile type notification 210, and proposal type notification 212.

In the present example, quorum type notification 206 may have been generated in response to detecting one or more issues based on one or more factors associated with an event (i.e., too many invitees declined attending the event). The one or more issues may have subsequently been classified as “quorum type” for which the quorum type notification 206 was generated comprising quorum type issue summary 230; quorum type detailed summary 234, which describes in more detail the identified issues; and selectable triage element 238, which is selectable to implement a suggested solution that may resolve the identified issue (e.g., cancel the event, reschedule the event). A priority criterion may have been applied to quorum type notification 206 such that quorum type notification 206 may be surfaced prior to, or after, surfacing meeting conflict type notification 202, missing location type notification 204, recommended reading type notification 208, profile type notification 210, and proposal type notification 212.

In the present example, recommended reading type notification 208 may have been generated in response to detecting one or more issues based on one or more factors associated with one or more events (i.e., slide presentation file “December Q4 All-Hands Deck” is associated with the event). For example, a zero-query/event triage application and/or service may have determined that slide presentation file “December Q4 All-Hands Deck” was associated with the event (i.e., was relevant to the event) based on query results that may have been obtained from natural language processing models, machine learning models, interactions of other invitees with the slide presentation file, keyword matching, and/or any other model for obtaining query results. As a result, the zero-query/event triage application and/or service may have identified the event has having one or more unresolved issues. The one or more unresolved issues may have subsequently been classified as a “recommended reading type” for which the recommended reading type notification 208 was generated comprising recommended reading type issue summary 240; recommended reading type detailed summary 244, which describes in more detail the identified issue; and selectable triage element 248, which is selectable to implement a suggested solution that may resolve the one or more issues (e.g., view the slide presentation). A priority criterion may have been applied to recommended reading type notification 208 such that recommended reading type notification 208 may be surfaced prior to, or after, surfacing meeting conflict type notification 202, missing location type notification 204, quorum type notification 206, profile type notification 210, and proposal type notification 212.

In the present example, profile type notification 210 may have been generated in response to detecting one or more issues based on one or more factors associated with one or more events (i.e., the invitee has not met another event invitee, Carl Carlson). For example, a zero-query/event triage application and/or service may have determined that an invitee has not met another invitee based on query results that indicated no emails are or were exchanged between certain invitees, no chat sessions are or were established between certain invitees, no event invitations include certain invitees, and/or no social media friendships are or were established between certain invitees. As a result, the zero-query/event triage application and/or service may have identified the event has having one or more unresolved issues. The one or more unresolved issues may have subsequently been classified as a “profile type” for which the profile type notification 210 was generated comprising profile type issue summary 250; profile type detailed summary 254, which describes in more detail the identified issue; and selectable triage element 258, which is selectable to implement a suggested solution that may resolve the one or more issues (e.g., surface event invitee Carl Carlson's LINKEDIN profile). A priority criterion may have been applied to profile type notification 210 such that profile type notification 210 may be surfaced prior to, or after, surfacing meeting conflict type notification 202, missing location type notification 204, quorum type notification 206, recommended reading type notification 208, and proposal type notification 212.

In the present example, proposal type notification 212 may have been generated in response to detecting one or more issues based on one or more factors associated with one or more events (i.e., an invitee sent a proposal to reschedule the event date and time). The one or more issues may have subsequently been classified as a “proposal type” for which the proposal type notification 212 was generated comprising proposal type issue summary 260; proposal type detailed summary 264, which describes in more detail the identified issue; and selectable triage element 268, which is selectable to implement a suggested solution that may resolve the one or more issues (e.g., open and review Katri's proposal). A priority criterion may have been applied to proposal type notification 212 such that proposal type notification 212 may be surfaced prior to, or after, surfacing meeting conflict type notification 202, missing location type notification 204, quorum type notification 206, recommended reading type notification 208, and profile type notification 210.

FIG. 3 illustrates a zero-query interface 300 surfaced on a mobile device (not shown) in an example implementation. Zero-query interface 300 includes query-slab 302A, query-slab 302B, and query-slab 302C. Each query-slab 302A-C may comprise one or more default queries that automatically obtain query results without explicit instruction from a user (e.g., an event invitee, an event organizer). Default queries may automatically obtain query results by applying query filters to analyze natural language processing models, analyze machine learning models, monitor interactions between users, monitor interactions between users and resources, apply keyword matching, and/or apply any other model for obtaining query results. Results obtained from query filters may be surfaced directly on a query-slab and/or integrated into user interface elements that may be surfaced on the query-slab. In embodiments, each of the elements depicted on zero-query interface 300 may be included on both an event organizer's user interface view of a zero-query search application and an invitee's user interface view of a zero-query search application. More or fewer elements may be included on a user interface of a zero-query application, and different arrangements and specific user interface configurations for displaying elements are contemplated than are shown in relation to FIG. 3.

In the present example, query-slab 302B comprises calendar actions element 304, event triage notification 306, and event triage notification 308. Calendar actions element 304 may indicate the number of unresolved issues identified with regard to a user's electronic calendar and/or other productivity application. Calendar actions element 304 may also indicate the number of unresolved issues identified for a single event whose details are saved to a user's electronic calendar and/or other productivity application. Unresolved issues may be identified and resolved using suggested reading processing flow 124, event quorum processing flow 130, location processing flow 136, and/or other conflicts processing flow 142, as described above with regards to FIG. 1. In the present example, calendar actions element 304 indicates that “6” unresolved issues have been identified. The number of unresolved issues indicated by calendar actions element 304 may increase as additional issues are identified (e.g., by a zero-query/event triage application and/or service). The number of unresolved issues indicated by calendar actions element 304 may decrease as a zero-query/event triage application and/or service determines that one or more of the identified issues have been resolved.

Event triage notifications 306 and 308 may be surfaced on query-slab 302B in response to a zero-query/event triage application and/or service identifying one or more unresolved issues. Event triage notifications 306 and 308 may be generated using suggested reading processing flow 124, event quorum processing flow 130, location processing flow 136, and/or other conflicts processing flow 142, as described above with regards to FIG. 1.

Event triage notifications may comprise multiple elements (e.g., one or more brief summaries of one or more unresolved issues, detailed information about one or more unresolved issues, one or more event details, one or more selectable event-triage elements, etc.). In the present example, event triage notification 306 comprises a brief summary of an unresolved issue (i.e., “Recommended read for”), the name of the event for which the issue was identified (i.e., “ALL HANDS MEETING”), detailed information for the unresolved issue (i.e., a presentation application file titled “December Q4 All-Hands Deck” that was last modified by Miguel Garcia 1 day ago), and selectable event-triage element 310. In other embodiments, each of the elements depicted in event triage notification 306 may be included in another event triage notification (e.g., event triage notification 308). More or fewer elements may also be included in other event triage notifications and different arrangements and specific configurations for displaying the elements are contemplated than are shown in relation to FIG. 3.

Examples of issue summaries include, but are not limited to: “recommended readings,” “people you haven't met,” “invitee proposed a new date and time,” “you have a meeting conflict,” “missing location,” “missing remote access,” “event does not have a quorum,” “conflict with event location,” “deliverables to prepare,” “vendors to contact,” “equipment needed,” “outstanding assignment,” etc. Other examples of issue summaries exist and are contemplated herein. Issue summaries may be generated based on information contained in the details of an event, attachments saved to an event's details page, a classification type of the identified issue, and/or other issue summary modeling criteria.

Event triage notifications may be surfaced in a user interface according to a priority criterion. The priority criterion may be based on a determined urgency to resolve the issue (e.g., models of user behavior indicate that a specific issue should be resolved immediately, models of user behavior indicate that a specific issue may be resolved after another unresolved issue is addressed, an event is scheduled to occur next in a user's calendar application or other productivity application) and/or the time it takes to complete a task that may resolve an identified issue (e.g., models of user behavior indicate that a user typically needs one week to prepare a presentation, two hours to prepare a three-page document, etc.). In the present example, event triage notification 306 is surfaced on query-slab 302B prior to event triage notification 308.

Selectable event-triage elements (e.g., selectable event-triage element 310) may comprise a description of a solution suggested to resolve the one or more identified issues (e.g., view document). Selectable event-triage elements may be selected to implement the suggested solution (e.g., to open a social media profile). While in some examples, the event-triage element is selectable to resolve one or more unresolved issues, in other examples the event triage notification is selectable to resolve the one or more unresolved issues. In the present example, when selectable event-triage element 310 is selected (e.g., a mouse-click, touch gesture, voice command, etc. is received by a computing device in association with the selectable event-triage element), then the “December Q4 All-Hands Deck” presentation application document may open in the user interface. In other examples, selectable event-triage elements may be selected to open attachments, related productivity documents, event agendas, suggested emails, messaging chats, notes, event transcription excerpts, social media profiles, calendaring applications and/or other productivity applications, etc. Identifying objects to associate with suggested solutions may be accomplished using suggested reading processing flow 124, event quorum processing flow 130, location processing flow 136, and/or other conflicts processing flow 142, as described above with regards to FIG. 1 and below in relation to FIG. 4.

FIG. 4 illustrates a computing environment 400 for node processing in a graphical matrix for providing event triage and recommending meeting pre-reads. This discussion in relation to computing environment 400 continues with description of the subject matter and examples described above in relation to FIG. 1, FIG. 2, and FIG. 3. Computing environment 400 depicts a portion of a graphical matrix comprising a plurality of resources (e.g., application documents, emails, saved instant message conversations, notes, social media profiles, etc.), which digitally connects resources to one another based on one or more attributes of those resources. Computing environment 400 also depicts the processing of one or more resources (in this case the future event resource 402) to determine whether a meeting agenda has been associated with an electronic future event. In some examples, values for each of a plurality of resources in the graphical matrix may be calculated as relating to future event resource 402 and/or one or more other resources in the graph, and a determination may be made based on those values as to whether to include those resources as suggested pre-reads associated with event triages for that event.

Computing environment 400 and the depicted graphical matrix includes attributes (A1, A2, A3, A4) 404, which correspond to future event resource 402; meeting agenda resource 412, which is illustrated as being a suggested pre-read in relation to pre-read 1 element 414; natural language processing and machine learning element 406; attachment A resource 416 with corresponding attributes (A1, A2, A3) 418, which is illustrated as being a suggested pre-read in relation to pre-read 2 element 420; attachment B resource 422 with corresponding attributes (A1, A2, A4) 424, which is illustrated as being a suggested pre-read in relation to pre-read 3 element 326; related document A resource 428 with corresponding attributes (A2, A3) 330, which is illustrated as being a suggested pre-read in relation to pre-read 4 element 432; and related document B resource 434 with corresponding attributes (A1, A4) 436, which is illustrated as being a suggested pre-read in relation to pre-read 5 element 438.

According to examples, attributes may be associated with each of the resources in the graphical matrix. The attributes may correspond to: time of creation and/or last edit; type of resource; content type; resource attachments (i.e., what other resources are attached to a resource); actual content; creators; modifiers; interaction history; and importance, for example. For example, attribute A1 may correspond to a time and/or date of resource creation and/or last edit, attribute A2 may correspond to a type of resource (e.g., word processing document, email document, presentation document, spreadsheet document, notes document, social media profile etc.), attribute A3 may correspond to a content type and/or classification of resource (e.g., relates to topic A, relates to topic B), and attribute A4 may correspond to whether a resource is directly attached to an electronic future event. A determination may thus be made based on attribute overlap amongst resources and/or based on the level of connectedness (e.g., first level from future event resource 402, second level removed from future event resource 402, etc.) as to whether to include a resource as a suggested pre-read event triage for a given meeting.

According to examples, one or more resources that have been determined to relate to a future event may be further processed to determine whether they correspond to a meeting agenda. In this example, the future event resource 402 (i.e., the content included in the future event) is processed by one or more machine learning models (e.g., machine learning model 408) and/or natural language processing models (e.g., natural language processing model 410) to determine whether a meeting agenda is included in the event. For example, language clustering models may be applied to text in a resource to determine whether a resource exceeds a threshold value for corresponding to a meeting agenda. In another example, a neural network may be applied to a resource, or portions thereof, to determine whether it should be classified as a meeting agenda. Once classified as a meeting agenda, the resource may be associated with an event in an electronic calendar application as a suggested pre-read event triage that may be interacted with and surfaced via a user interface.

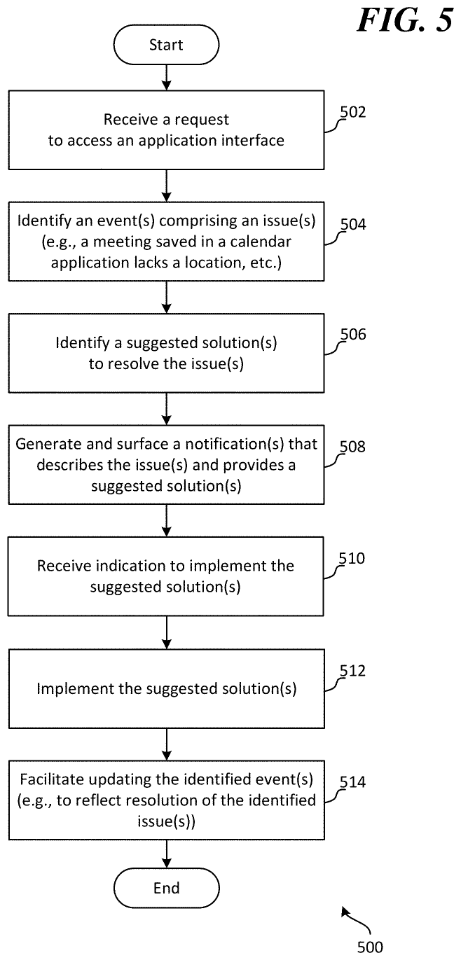

FIG. 5 is an exemplary method 500 for providing event triage for an event having details saved to an electronic calendar and/or other productivity application. The method 500 may be implemented by a zero-query/event triage application and/or service via a computing device (e.g., server computing device 108, a client computing device, a mobile computing device). The method 500 begins at a start operation and flow continues to operation 502.

At operation 502, the zero-query/event triage application and/or service receives a request (e.g., from a client computing device) to access an application interface (e.g., a zero-query interface). The application interface may comprise a query-slab that may comprise user interface elements and/or a default search query. The default search query may obtain results by applying query filters to analyze natural language processing models, analyze machine learning models, monitor interactions between users, monitor interactions between users and resources, apply keyword matching, and/or apply any other model for obtaining query results. Results obtained from query filters may be surfaced directly on a query-slab and/or integrated into user interface elements that are surfaced on the query-slab.

Flow continues from operation 502 to operation 504 where the zero-query/event triage application and/or service identifies one or more events, comprising one or more unresolved issues, in one or more calendar applications and/or other productivity applications. The one or more events and/or unresolved issues may be identified based on one or more of suggested reading processing flow 124, event quorum processing flow 130, location processing flow 136, and other conflicts processing flow 142, as discussed above with regard to FIG. 1. In some implementations, the one or more unresolved issues may comprise materials to be read and/or reviewed (e.g., attachments, related productivity documents, event agendas, suggested emails, messaging chats, notes, event transcription excerpts, social media profiles, etc.); failure to obtain a meeting quorum (e.g., not enough invitees responded in the affirmative that they will attend an event); an invitee proposing a new date and/or time for an event; failure to provide an event location; a stated location not being available (e.g., another meeting is scheduled for the location on the same date and time, the proposed room and/or building is closed, etc.); a missing remote-access option; multiple events scheduled for the same date and time; and materials that may be needed for the event (e.g., presentation materials, booking vendors, obtaining equipment, etc.); and other issues associated with calendared events.

From operation 504, flow continues to operation 506 where the zero-query/event triage application and/or service identifies one or more suggested solutions to resolve the one or more unresolved issues associated with the one or more events identified at operation 504. According to examples, solutions for unresolved issues may be identified based on one or more attributes of an unresolved issue. The one or more attributes may comprise: the type of issue (e.g., recommended reading type), documents associated with an event (e.g., event attachment), elements missing from an event (e.g., remote access option), conflicts between events (e.g., events are double-booked), proposals associated with an event (e.g., request to reschedule), missing connection between invitees (e.g., invitees have never met), failure to meet a quorum (e.g., not enough people indicated they are attending an event), etc.

In some implementations, suggested solutions may comprise reading/reviewing one or more items (e.g., documents, attachments, related productivity documents, event agendas, suggested emails, messaging chats, notes, event transcription excerpts, social media profiles, proposals, invitee profiles, etc.), resolving conflicts (e.g., rescheduling a meeting, relocating an event, providing a remote-access option, etc.), accessing an electronic calendar and/or other productivity application, and other solutions for triaging an event are contemplated herein.

From operation 506, flow continues to operation 508 where the zero-query/event triage application and/or service generates and surfaces an event triage notification. The event triage notification may comprise one or more brief summaries of one or more of the unresolved issues associated with the one or more events identified at operation 504. The event triage notification may also comprise one or more detailed summaries of one or more of the issues. The event triage notification may further comprise one or more event details associated with one or more of the events identified at operation 504. Event triage notification may also comprise one or more selectable event-triage elements, which may be selectable to implement one or more of the suggested solutions identified at operation 506.

From operation 508, flow continues to operation 510 where the zero-query/event triage application and/or service receives an indication to implement one or more of the suggested solutions determined at operation 506. For example, a selectable event-triage element may have been selected (e.g., a mouse-click, touch gesture, voice command, etc. was received by a computing device in association with one or more of the selectable event-triage elements), thus indicating to the zero-query/event triage application and/or service that one or more of the suggested solutions may be implemented.

From operation 510, flow continues to operation 512 where the zero-query/event triage application and/or service implements the one or more suggested solutions. The one or more suggested solutions may be implemented when the zero-query/event triage application sends a request to access and open in a user interface: a document, electronic calendar and/or other productivity application, attachment, chat session, messaging application, social media application, event agenda, suggested emails, notes, invitee profile, etc. The one or more suggested solutions may also be implemented when the zero-query/event triage application automatically generates and sends one or more messages for responding to one or more invitees that proposed rescheduling an event and/or for responding to one or more other types of proposals. The one or more suggested solutions may further be implemented when the zero-query/event triage application facilitates adding and/or updating an event location. The one or more suggested solutions may further be implemented when the zero-query/event triage application facilitates adding and/or updating remote-access options that enable invitees to attend an event remotely. Other methods for implementing the one or more suggested solutions exist and are contemplated herein.

From operation 512, flow continues to operation 514 where the zero-query/event triage application and/or service facilitates updating one or more of the events identified at operation 504 to reflect resolution of one or more of the unresolved issues associated with the one or more events identified at operation 504. The zero-query/event triage application and/or service may facilitate updating one or more events by sending a request to an electronic calendar application and/or other productivity application to update one or more events whose data may be stored therein. Alternatively, the zero-query/event triage application and/or service may facilitate updating one or more events by performing the update directly through the zero-query/event triage application and/or service.

From operation 514, flow moves to an end operation and the method 500 ends.

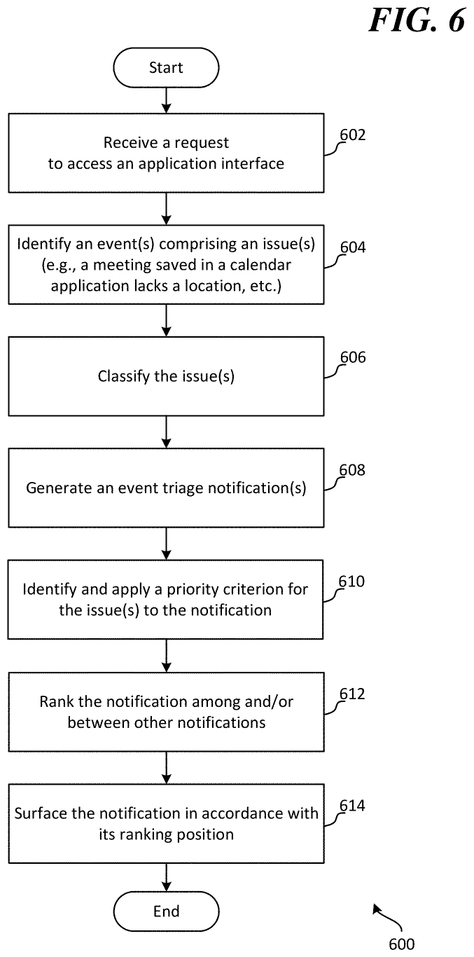

FIG. 6 is an exemplary method 600 for providing event triage for an event having details saved to an electronic calendar and/or other productivity application. The method 600 may be implemented by a calendar triage application and/or service via a computing device (e.g., server computing device 108, a client computing device, a mobile computing device). The method 600 begins at a start operation and flow continues to operation 602.

At operation 602, the zero-query/event triage application and/or service receives a request (e.g., from a client computing device) to access an application interface (e.g., a zero-query interface). The application interface may comprise a query-slab that may comprise user interface elements and/or a default search query. The default search query may obtain results by applying query filters to analyze natural language processing models, analyze machine learning models, monitor interactions between users, monitor interactions between users and resources, apply keyword matching, and/or apply any other model for obtaining query results. Results obtained from query filters may be surfaced directly on a query-slab and/or integrated into user interface elements that are surfaced on the query-slab.

From operation 602, flow continues to operation 604 where the zero-query/event triage application and/or service identifies one or more events, comprising one or more unresolved issues, in one or more calendar applications and/or other productivity applications. The one or more events and/or unresolved issues may be identified based on one or more of suggested reading processing flow 124, event quorum processing flow 130, location processing flow 136, and other conflicts processing flow 142, as discussed above with regard to FIG. 1. In some implementations, the one or more unresolved issues may comprise materials to be read and/or reviewed (e.g., attachments, related productivity documents, event agendas, suggested emails, messaging chats, notes, event transcription excerpts, social media profiles, etc.); failure to obtain a meeting quorum (e.g., not enough invitees responded in the affirmative that they will attend an event); an invitee proposing a new date and/or time for an event; failure to provide an event location; a stated location not being available (e.g., another meeting is scheduled for the location on the same date and time, the proposed room and/or building is closed, etc.); a missing remote-access option; multiple events scheduled for the same date and time; and materials that may be needed for the event (e.g., presentation materials, booking vendors, obtaining equipment, etc.); and other issues associated with calendared events.

From operation 604, flow continues to operation 606 where the zero-query/event triage application and/or service classifies the one or more unresolved issues associated with the one or more events identified at operation 604 into issue types. An appropriate issue type to apply to an issue may be determined based on one or more factors associated with one or more events. Examples of issue type classifications may include, but are not limited to: a recommended reading type, a profile type, a link type, a productivity document type, an email type, an agenda type, a social media profile type, a rescheduling type, a proposal type, a location type, a missing location type, a remote option type, a meeting conflict type, a preparation type, a vendor type, an equipment type, a suggested reading type, a quorum type, etc.

From operation 606, flow continues to operation 608 where the zero-query/event triage application and/or service generates and surfaces an event triage notification. The event triage notification may comprise one or more brief summaries of one or more of the unresolved issues associated with the one or more events identified at operation 604. The event triage notification may also comprise one or more detailed summaries of one or more of the issues. The event triage notification may further comprise one or more event details associated with one or more of the events identified at operation 604.

From operation 608, flow continues to operation 610 where the zero-query/event triage application and/or service identifies and applies a priority criterion for one or more unresolved issue to an event triage notification based at least on the issue type classification applied to the one or more of the issues at operation 606. In some examples, a priority criterion may be based on a determined urgency to resolve the issue (e.g., models of user behavior indicate that a specific issue should be resolved immediately, models of user behavior indicate that a specific issue may be resolved after resolving another issue, an event is scheduled to occur next in a user's calendar application or other productivity application, etc.) and/or the time it takes to complete a task that may resolve the identified issue (e.g., models of user behavior indicate that a user typically needs one week to prepare a presentation, two hours to prepare a three-page document, etc.). Determining which priority criterion to apply to a notification may be based in part on the classification of the issue type.

From operation 610, flow continues to operation 612 where the zero-query/event triage application and/or service ranks an event triage notification among and/or between other event triage notifications. In some examples, event triage notifications are ranked based on the priority criterion applied to the notification at operation 608. A priority criterion may provide a higher or lower priority ranking than another priority criterion.

From operation 612, flow continues to operation 614 where the zero-query/event triage application and/or service surfaces an event triage notification according to the ranking applied to the event triage notification at operation 612. In some examples, the event triage notification is surfaced according to its postion in a priority order. For example, when an event triage notification has a higher priority ranking (e.g., on a priority ranking scale of 1 to 10, a priority ranking of 10 is higher than a priority ranking of 1), or a higher placement in a priority order (e.g., on a priority order scale of 1 to 10, a placement of 10 in a priority order is higher than a placement of 1), than another event triage notification, then the event triage notification may be surfaced prior to surfacing the other event triage notification. In another example, when an event triage notification has a lower priority ranking than another event triage notification (e.g., on a priority ranking scale of 1 to 10, a priority ranking of 1 is lower than a priority ranking of 10), or a lower placement in a priority order (e.g., on a priority order scale of 1 to 10, a placement of 1 in a priority order is lower than a placement of 10), than another event triage notification, then the event triage notification may be surfaced prior to surfacing the other event triage notification. In some embodiments, the date and/or time of a future event may also be a factor when determining priority ranking and/or placement in a priority order.

From operation 610, flow continues to an end operation and method 600 ends.

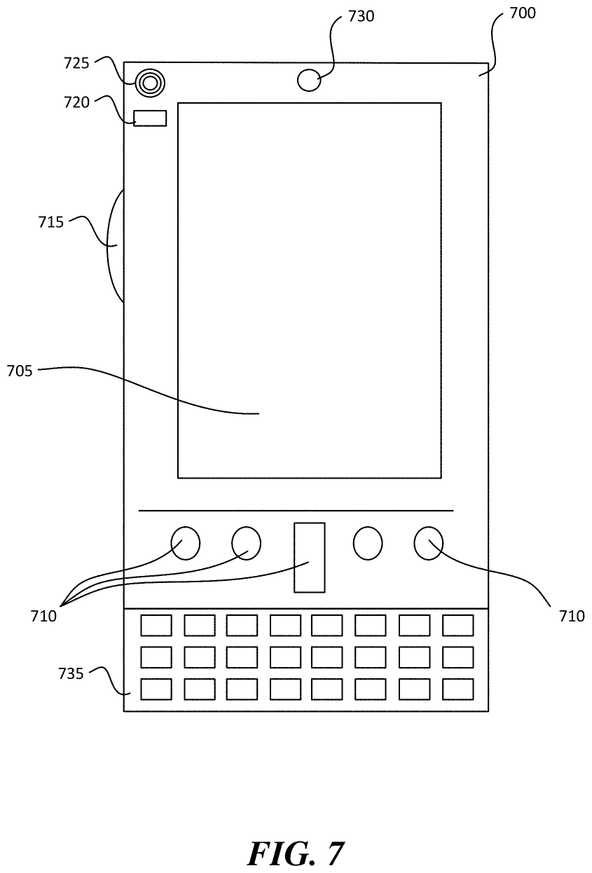

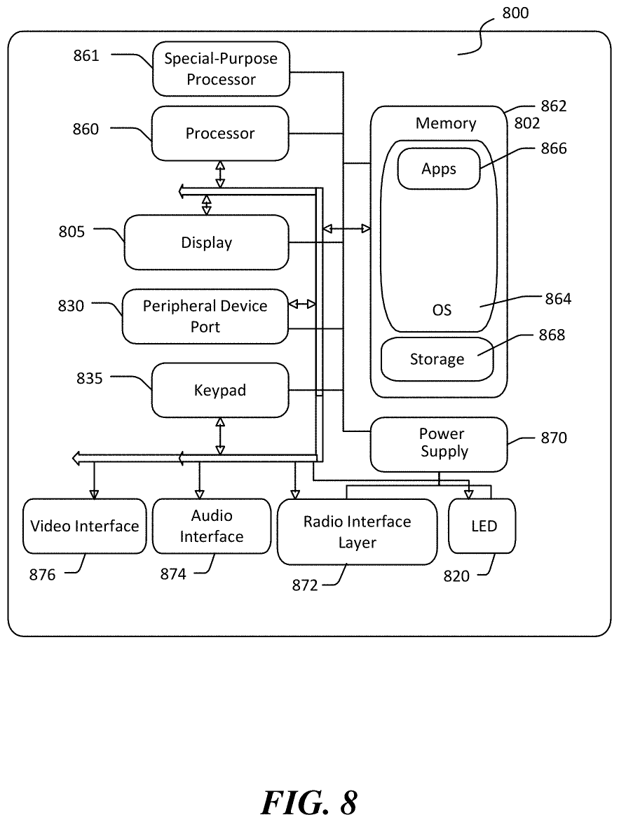

FIGS. 7 and 8 illustrate aspects of a mobile computing device with which aspects of the disclosure may be practiced (e.g., a mobile telephone, a smart phone, wearable computer [such as smart eyeglasses], a tablet computer, an e-reader, a laptop computer, or other augmented-reality compatible computing device). With reference to FIG. 7, one aspect of a mobile computing device 700 is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or fewer input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI) (e.g., the user interface illustrated in FIG. 3), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 8 is a block diagram illustrating the architecture of one aspect of a mobile computing device 800. That is, the mobile computing device 800 can incorporate a system 802 (e.g., an architecture) to implement some aspects. In one example, the system 802 is implemented as a “smart phone” capable of running one or more applications (e.g., browser, e-mail, calendaring, contact managers, messaging clients, games, and media clients/players). In some embodiments, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800, including instructions for providing and operating a digital assistant computing platform.

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via an audio transducer (e.g., audio transducer 725 of FIG. 7). In the illustrated embodiment, the visual indicator 820 is a light emitting diode (LED) and the audio transducer is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8 by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

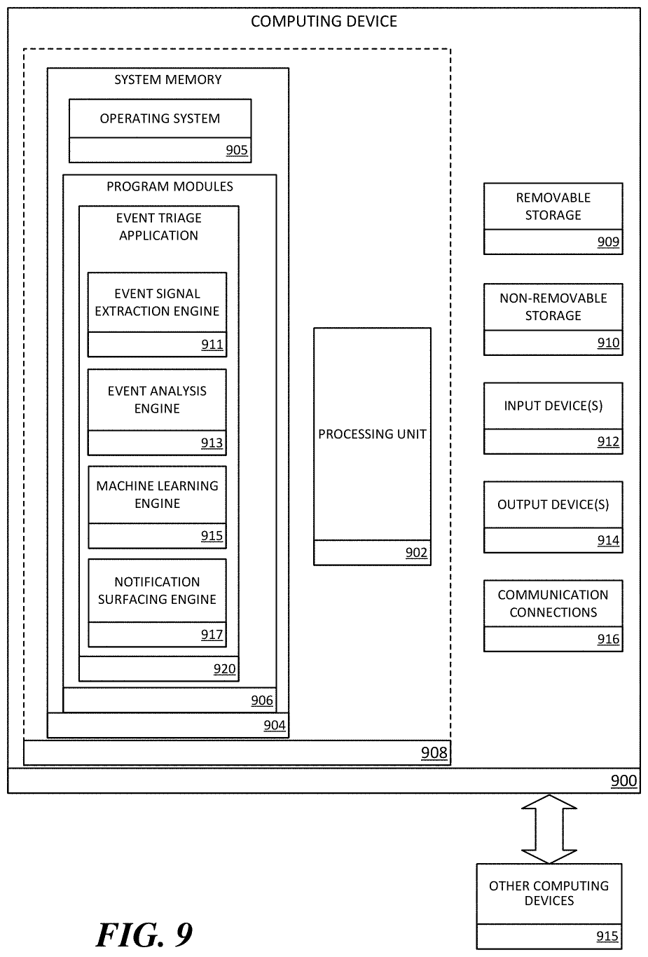

FIG. 9 is a block diagram illustrating physical components (e.g., hardware) of a computing device 900 with which aspects of the disclosure may be practiced (e.g., server computing device 108 of FIG. 1). The computing device components described below may have computer executable instructions for generating, surfacing and providing operations associated with event triage. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories. The system memory 904 may include an operating system 905 suitable for running one or more digital assistant programs. The operating system 905, for example, may be suitable for controlling the operation of the computing device 900. Furthermore, embodiments of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the processing unit 902, the program modules 906 (e.g., zero-query/event triage application 920) may perform processes including, but not limited to, the aspects, as described herein. According to examples, the event signal extraction engine 911 may perform one or more operations associated with identifying one or more signals associated with events and/or event invitations. The event analysis engine 913 may perform one or more operations associated with determining whether one or more resources are associated with one another and/or with one or more events based on analysis of one or more shared signals. The machine learning engine 915 may perform one or more operations associated with applying one or more machine learning models to one or more resources to determine whether they include content relevant to an event and/or whether an event invite includes a meeting agenda. The notification surfacing engine 917 may perform one or more operations associated with surfacing notifications in association with an event triage and providing follow-up actions when interactions with those notifications are received.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The computing device 900 may include one or more communication connections 916 allowing communications with other computing devices 950. Examples of suitable communication connections 916 include, but are not limited to, radio frequency (RF) transmitter, receiver, and/or transceiver circuitry; universal serial bus (USB), parallel, and/or serial ports.

Computer readable storage media may include volatile and nonvolatile, removable and non-removable media implemented in any method or technology for storage of information, such as computer readable instructions, data structures, or program modules. The system memory 904, the removable storage device 909, and the non-removable storage device 910 are all examples of computer readable storage media (e.g., memory storage). Computer readable storage media may include RAM, ROM, electrically erasable read-only memory (EEROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. In no case is the computer readable storage media a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

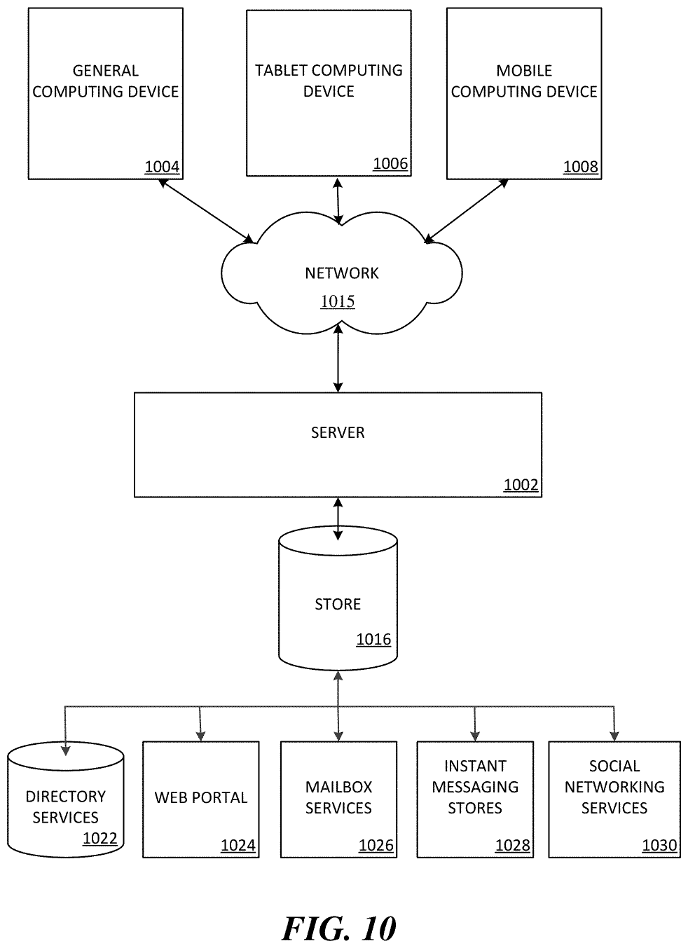

FIG. 10 illustrates one aspect of the architecture of a system for processing data received at a computing system from a remote source, such as a personal/general computer 1004, tablet computing device 1006, or mobile computing device 1008, as described above. Content displayed at server device 1002 may be stored in different communication channels or other storage types. For example, various documents may be stored using a directory service 1022, a web portal 1024, a mailbox service 1026, an instant messaging store 1028, or a social networking site 1030. The program modules 906 may be employed by a client that communicates with server device 1002, and/or the program modules 906 may be employed by server device 1002. The server device 1002 may provide data to and from a client computing device such as a personal/general computer 1004, a tablet computing device 1006 and/or a mobile computing device 1008 (e.g., a smart phone) through a network 1015. By way of example, the computer systems described herein may be embodied in a personal/general computer 1004, a tablet computing device 1006 and/or a mobile computing device 1008 (e.g., a smart phone). Any of these embodiments of the computing devices may obtain content from the store 1016, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer implemented method for providing event triage, the method comprising:
surfacing, on a zero-query interface, a query-slab related to a future event, wherein the future event has an unresolved issue;
executing an automated query for identifying the unresolved issue;
identifying a solution for resolving the un resolved issue by applying one or more query filters to a productivity application, wherein the one or more query filters comprise a reference to contextual information related to the future event; and
surfacing, on the query-slab, a notification selectable to implement the solution for resolving the unresolved issue.

2. The method of claim 1 further comprising:
identifying, by applying the one or more query filters, a second-future event that comprises a second-issue; and
surfacing, on the query-slab, a second-notification selectable to implement a second-solution for resolving the second-issue.

3. The method of claim 2 further comprising:
classifying the unresolved issue with an issue type;
applying a priority criterion to the notification based on the issue type;
classifying the second-issue with a second-issue type;
applying a second-priority criterion to the second-notification based on the second-issue type; and
surfacing the notification and the second-notification on the query-slab in an order based at least on the priority criterion and the second-priority criterion.

4. The method of claim 3 wherein the issue type comprises one of a recommended reading type, a quorum type, a proposal type, a location type, or a meeting conflict type.

5. The method of claim 2 wherein the second-future event is saved to a second-productivity application.

6. The method of claim 1 further comprising:
receiving, via the zero-query interface, an indication to implement the solution; and
implementing the solution.

7. The method of claim 6 wherein implementing the solution comprises at least one of opening an electronic calendar application, opening a word processing application, opening a spreadsheet application, surfacing a document, surfacing an invitee profile, surfacing a dialer application, and sending a message to an invitee.

8. The method of claim 6 further comprising updating the future event to demonstrate a resolution of the unresolved issue.

9. The method of claim 1 wherein the unresolved issue comprises at least one of a recommended reading, a missing location, a conflict with a location, a failure to meet a quorum, and an outstanding assignment.

10. The method of claim 1 wherein the solution comprises at least one of a document to read, a profile to review, an option to add a location to the future event, and an option to reschedule the future event.

11. The method of claim 1 wherein the contextual information comprises edges between nodes of a graphical matrix.

12. The method of claim 1 wherein the contextual information comprises language clustering models.

13. The method of claim 1 wherein the contextual information comprises an events detail page.

14. The method of claim 1 wherein the notification comprises issue details that describe the issue and solution details that describe the solution.

15. A computer-readable storage device comprising executable instructions that, when executed by one or more processors, assist with event triage, the computer-readable storage device including instructions executable by the one or more processors for:
surfacing, on a zero-query interface, a query-slab related to a future event, wherein the future event has an unresolved issue;
executing an automated query for identifying the unresolved issue;
identifying a solution for resolving the unresolved issue by applying one or more query filters to a productivity application, wherein the one or more query filters comprise a reference to contextual information related to the future event; and
surfacing, on the query-slab, a notification selectable to implement the solution for resolving the unresolved issue.

16. The computer readable storage device of claim 15, wherein the executable instructions are further executable by the one or more processors for:
identifying, via the one or more query filters, a second-future event that comprises a second-issue; and
surfacing, on the query-slab, a second-notification selectable to implement a second-solution for resolving the second-issue.

17. The computer readable storage device of claim 16, wherein the executable instructions are further executable by the one or more processors for:
classifying the unresolved issue with an issue type;
applying a priority criterion to the notification based on the issue type;
classifying the second-issue with a second-issue type;
applying a second-priority criterion to the second-notification based on the second-issue type; and
surfacing the notification and the second-notification on the query-slab in an order based at least on the priority criterion and the second-priority criterion.

18. A computer apparatus comprising:
computer readable storage device;
a processor operatively coupled with the computer readable storage device; and
program instructions stored on the computer readable storage device that, when executed by the processor, direct the computer apparatus to at least:
surface, on a zero-query interface, a query-slab related to a future event, wherein the future event has an unresolved issue;
execute an automated query for identifying the unresolved issue;
identify a solution for resolving the unresolved issue by applying one or more query filters to a productivity application, wherein the one or more query filters comprise a reference to contextual information related to the future event; and
surface, on the query-slab, a notification selectable to implement the solution for resolving the unresolved issue.

19. The computer apparatus of claim 18, wherein the program instructions, when executed by the processor, further direct the computer apparatus to:
identify, via the query filters, a second-future event that comprises a second-issue; and
surface, on the query-slab, a second-notification selectable to implement a second-solution for resolving the second-issue.

20. The computer apparatus of claim 19, wherein the program instructions, when executed by the processor, further direct the computer apparatus to:
classify the unresolved issue with an issue type;
apply a priority criterion to the notification based on the issue type;
classify the second-issue with a second-issue type;
apply a second-priority criterion to the second-notification based on the second-issue type; and
surface the notification and the second-notification on the query-slab in an order based at least on the priority criterion and the second-priority criterion.
